(19) United States
(12) Patent Application Publication
(10) Pub. No.: US 2008/0100812 A1
(43) Pub. Date: May 1, 2008

(54) Immersion lithography system and method having a wafer chuck made of a porous material

(75) Inventors: Alex Ka Tim Poon, San Ramon, CA (US); Leonard Wai Fung Kho, San Francisco, CA (US); Gaurav Keswani, Fremont, CA (US); Derek Coon, Redwood City, CA (US)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/907,218

(22) Filed: Oct. 10, 2007

Related U.S. Application Data
(60) Provisional application No. 60/854,442, filed on Oct. 26, 2006.

(51) Int. Cl. G03B 27/52; G03C 5/00

(52) U.S. Cl. 355/30; 430/322

(57) ABSTRACT

An immersion lithography apparatus having a substrate chuck made of a porous material. The porous substrate chuck is provided to contact and support the back surface of the substrate and hold the substrate in place. The porous substrate chuck facilitates in the removal of any immersion liquid under the substrate.

### RELATED APPLICATIONS

This application claims priority on Provisional Application Ser. No. 60/854,442 filed on Oct. 26, 2006 and entitled “Use of Porous Material on Wafer Table for Fluid Recovery”, the content of which is incorporated herein by reference for all purposes.

### BACKGROUND

1. Field of the Invention

The present invention relates to immersion lithography, and more particularly, to a substrate chuck made of a porous material to facilitate in the removal of any immersion fluid, which may collect under the substrate while in contact with the immersion fluid.

2. Related Art

A typical lithography tool includes a radiation source, a projection optical system, and a substrate stage to support and move a substrate to be imaged. A radiation-sensitive material, such as resist, is coated onto the substrate surface prior to placement onto the substrate stage. During operation, radiation energy from the radiation source is used to project an image defined by an imaging element, for example a mask or a reticle, through the projection optical system onto the substrate. The projection optical system typically includes a number of lenses. The lens or optical element closest to the substrate is often referred to as the “last” or “final” optical element.

The projection area during an exposure is typically much smaller than the surface of the substrate. The substrate therefore has to be moved relative to the projection optical system to pattern the entire surface. In the semiconductor industry, two types of lithography tools are commonly used. With so-called “step and repeat” tools, the entire image pattern is projected at once in a single exposure onto a target area of the substrate. After the exposure, the wafer is moved or “stepped” in the X and/or Y direction and a new target area is exposed. This step and repeat process is performed over and over until the entire substrate surface is exposed. With scanning type lithography tools, the target area is exposed in a continuous or “scanning” motion. The imaging element is moved in one direction while the substrate is moved in either the same or the opposite direction during exposure. The substrate is then moved in the X and/or Y direction to the next scan target area. This process is also repeated until all the desired areas on the substrate have all been exposed.

With both step and repeat and scanning type lithography tools, a chuck is used to secure the substrate in place during exposure. The chuck is typically positioned on a stage assembly. The chuck holds the substrate in place while the stage assembly moves the chuck in the X and/or Y directions during the step and repeat or scanning motion. Vacuum and electrostatic chucks, or a combination thereof, are known in the art. With vacuum chucks, vacuum ports are provided in the chuck to suck and hold the substrate in place on the chuck surface. With electrostatic chucks, the substrate is held in place by an electrostatic force.

It should be noted that lithography tools are typically used to image or pattern semiconductor wafers and flat panel displays. The term “substrate” as used herein is intended to generically mean any work piece that can be patterned, including, but not limited to, semiconductor wafers and flat panel displays.

Immersion lithography systems use a layer of fluid that fills a gap between the final optical element of the projection optical system and the substrate. The fluid enhances the resolution of the system by enabling exposures with a numerical aperture (NA) greater than one, which is the theoretical limit for conventional “dry” lithography. The fluid in the gap permits the exposure with radiation that would otherwise be completely internally reflected at the optical-air interface. With immersion lithography, numerical apertures as high as the index of refraction of the fluid are possible. Immersion also increases the depth of focus for a given NA, which is the tolerable error in the vertical position of the substrate, compared to a conventional dry lithography system. Immersion lithography thus has the ability to provide greater resolution than can be performed using conventional dry lithography.

In immersion systems, the fluid essentially becomes part of the optical system of the lithography tool. The optical properties of the fluid therefore must be carefully controlled. The optical properties of the fluid can be influenced by the composition of the fluid, temperature, the absence or presence of gas bubbles, and out-gassing from the resist on the wafer.

One known way of maintaining the immersion fluid in the gap where exposure of the substrate is to occur is the use of an air curtain. With an air curtain design, an immersion element, with air jets, surrounds the last optical element of the projection optical system. The air jets are used to create a curtain of air surrounding the exposure area, maintaining the fluid localized within the gap under the last optical element. For more information on air curtain type immersion tools, see for example U.S. Patent publication 2005/0007569 A1 and U.S. Patent publication 2004/0207824 A1, incorporated by reference herein for all purposes.

Another known way of maintaining the immersion fluid within the gap of a lithography tool is with the use of a liquid confinement member that surrounds the last optical element immediately above the area to be exposed on the substrate. The liquid confinement member includes one or more fluid inlets that introduce the immersion fluid into the gap. The liquid confinement member may also include one or more porous elements, pulling, for example, a vacuum below the “bubble point” of the porous elements; through which the immersion fluid is recovered. For more information on this type immersion lithography tools, see U.S. Patent Publication 2006/0152697 A1, and U.S. application Ser. No. 11/597,442 or PCT/US2005/14200, all incorporated herein by reference for all purposes.

It is also known to maintain the immersion fluid in the gap between the last optical element and the imaging surface of the substrate by submersing the substrate in immersion fluid. See for example U.S. Pat. No. 4,509,852, also incorporated by reference herein.

With immersion lithography, regardless of the specific design, all have a similar issue. Chucks for most immersion lithography tools are made from a non-porous material such as silicon carbide or ceramic. Sometimes the immersion fluid seeps or otherwise collects between the bottom surface of the substrate and the chuck. This is problematic for several reasons. When fluid collects between the bottom of the substrate and the chuck, removing the substrate from the chuck after exposure may become very difficult due to surface tension. Consequently, a larger force may be needed for removal, which may cause the substrate to break. Also if the substrate is wet after removal from the chuck, the fluid may drip and contaminate other systems in the lithography tool. For example, the substrate handling subsystem or the metrology subsystem of the tool may be adversely affected by inadvertent contact with the immersion fluid.

### SUMMARY

An immersion lithography apparatus having a substrate chuck made of a porous material. The porous substrate chuck is provided to contact and support the back surface of a substrate and hold the substrate in place. The porous substrate chuck facilitates in the removal of any immersion liquid under the substrate.

### BRIEF DESCRIPTION OF THE DRAWINGS

FIG. 1 is a diagram of a lithography tool having a porous substrate chuck according to the present invention.

FIG. 2 is a top view of the porous substrate chuck of the present invention.

FIG. 3 is a cross section view of the porous wafer chuck according to one embodiment of the present invention.

FIG. 4 is a cross section view of the porous wafer chuck according to another embodiment of the present invention.

FIG. 5 is a cross section view of the porous substrate chuck in an immersion tool using an immersion nozzle according to one embodiment of the present invention.

FIG. 6 is a cross section view of the porous substrate chuck in an immersion tool having a confinement plate according to another embodiment of the present invention.

FIG. 7 is a cross section view of the porous substrate chuck in an immersion tool using an air curtain according to yet another embodiment of the present invention.

FIGS. 8A and 8B are flow diagrams illustrating the sequence of fabricating semiconductor wafers according to the present invention.

Like reference numerals in the figures refer to like elements.

### DETAILED DESCRIPTION

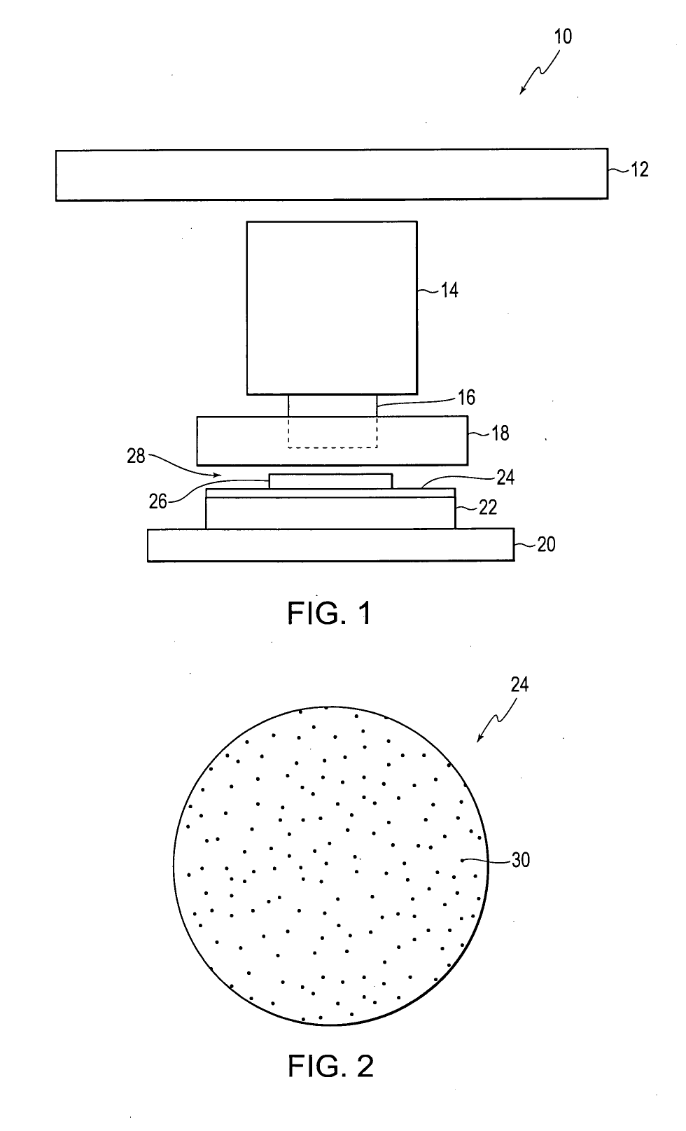

Referring to FIG. 1, an immersion tool or apparatus is shown. The immersion apparatus 10 includes an imaging element 12 which defines an image, a projection optical system 14 which includes a “last” or “final” optical element 16, an immersion device 18, a coarse stage 20, a fine stage 22, and a porous substrate chuck 24 for holding a substrate 26. The substrate can be positioned under the last optical element 16 with a gap 28 between the top surface of the substrate and the last optical element 16. The immersion device 18 maintains an immersion fluid (not visible) in the gap 28 between the substrate 26 and the last optical element 16.

Prior to imaging, a substrate is loaded onto the porous chuck 24 and the immersion device 18 fills the gap 22 with immersion fluid. During operation, the fine and coarse stages 22, 20 scan or steps the substrate 26 under the projection optical system 14 so that a selected target area on the surface of the substrate 26 is positioned under the last optical element 16. The projection optical system then exposes the image defined by the imaging element 12 onto the targeted area. The substrate 26 is then stepped or scanned to a new target area and exposed again. This process is repeated over and over until the entire imaging surface of the substrate 26 is exposed. With each exposure, the image defined by the imaging element 12 is projected through the projection optical system 14, the last optical element 16, and the immersion fluid in gap 28 onto the surface of the substrate 26.

In one embodiment, the imaging element 12 is a reticle or mask. In other embodiments, the imaging element 12 is a programmable micro-mirror array capable of generating an image, such as described in U.S. Pat. Nos. 5,296,891, 5,523,193, and PCT Application Nos. WO98/38597 and 98/330096, all incorporated herein by reference. In various embodiments, the fine stage 22 is supported by the coarse stage 20 by magnetic levitation, air bellows, pistons, vacuum, or springs, or a combination thereof, as are all well known in the art. The fine stage 22 is responsible for fine position adjustments of the chuck 24 and substrate 26 in, depending on the design, anywhere from one to six degrees of freedom (x, y, z, βx, ⊖y and ⊖z). Similarly, the coarse stage 20 is responsible for moving the fine stage 22 in one to six degrees of freedom. The porous chuck 24 is typically flush mounted with the top surface of the fine stage 22 and held in place by magnets, a vacuum, or mechanical fasteners such as screws, or a combination thereof.

FIG. 2 is a top view of the porous substrate chuck 24. The chuck is made of a porous material, such as ceramic, that includes a plurality of pores 30 over the entire top surface area. In various embodiments, the individual pores 30 may have a opening ranging from 0.1 microns to 5.0 microns. It should be noted that the pores are not necessarily round or be uniformly the same size. The size of the pores may vary. The pores can assume a number of different shapes and sizes. For example, the pores can be coarser and of a larger size at the outer periphery of the chuck 24 and smaller and finer in the inner regions of the chuck, or vice-versa.

The chuck 24 may also be made from a number of porous materials, including but not limited to ceramic, metal and or glass. As illustrated, the chuck 24 is a circular shaped disk and is made to be larger in size than the substrate it is intended to hold. For example, if the substrate 26 is a 300 millimeter wafer, then the diameter of the chuck will range from 300 to 500 millimeters to hold either smaller or larger sized substrates. In other embodiments, the diameter of the chuck 24 can be made to be the same size or smaller than the substrate 26 it is intended to hold.

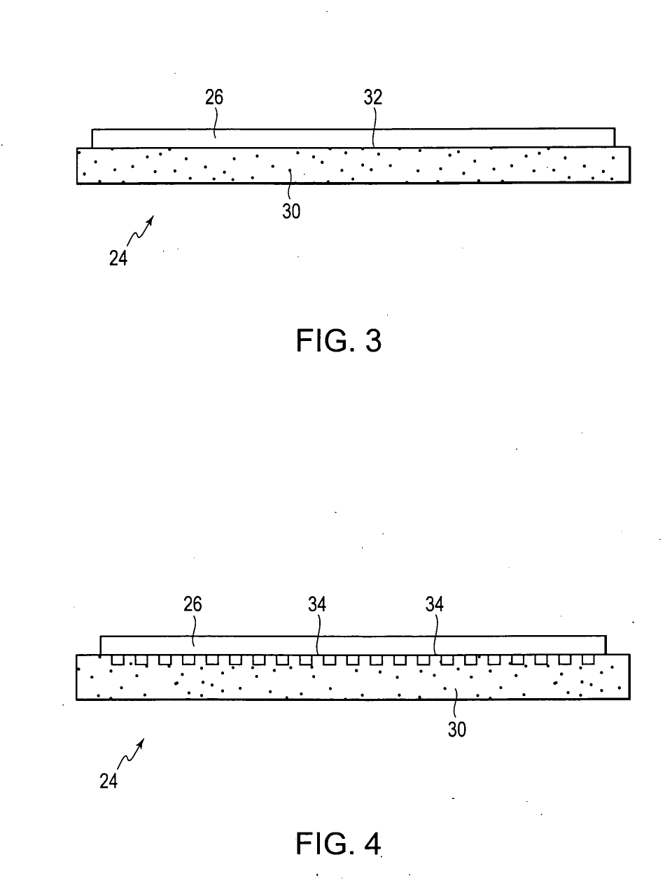

FIG. 3 shows one embodiment of the porous wafer chuck 24. FIG. 3 is a cross section view of the porous wafer chuck 24 according to one embodiment. The chuck 24 in this embodiment has a flat top surface for supporting the substrate 26. In various embodiments, the chuck has a thickness ranging from 10 to 50 millimeters. As evident in the figure, the pores 30 are provided completely through the height or thickness of the chuck 24. The pores enable fluid, such as gas (air) and any liquids, to pass through the thickness of the chuck 24.

FIG. 4 shows another embodiment of the porous chuck 24, FIG. 4 is a cross section of the porous chuck 24. In this embodiment, a plurality of pins 34 are provide across the top surface of the chuck 24. The substrate 26 is placed on and is supported by the pins 34. In various embodiments, the pins 34 have a height ranging from 10 to 100 microns and a size ranging from 500 to 5000 microns. Like the embodiment above, the pores 30 enable fluid, such as gas (air) and liquids, to pass through the thickness of the chuck 24.

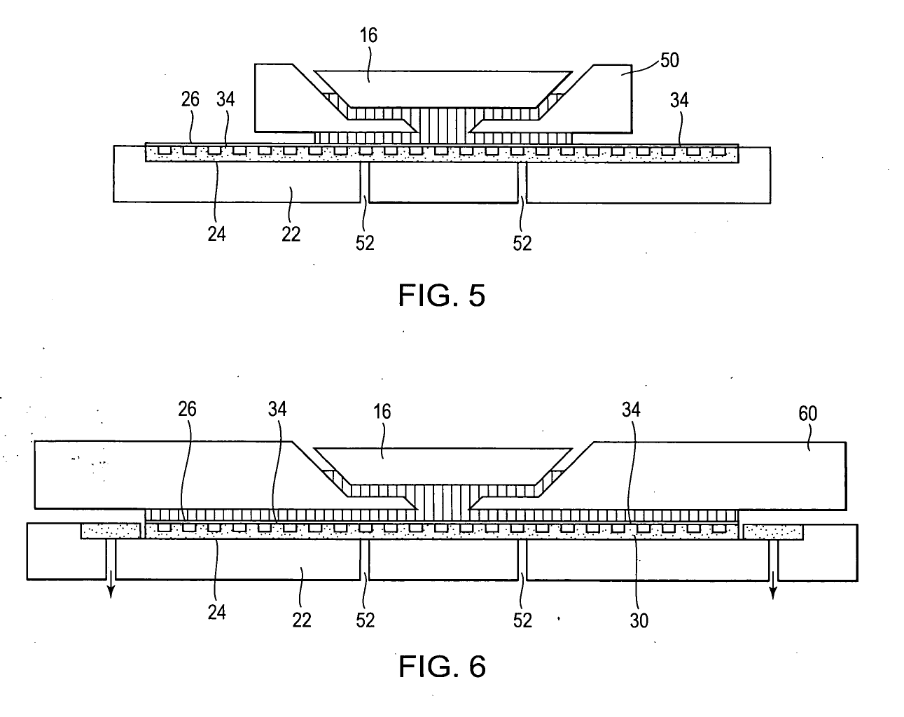

FIG. 5 shows one embodiment of the porous chuck 24 in an immersion tool 10 using a liquid confinement member. FIG. 5 is a detailed cross section view of this embodiment. In this embodiment, the immersion device 18 as shown in FIG. 1 includes a fluid confinement member 50 that substantially surrounds the last optical element 16 of the optical system 14 (not illustrated) and maintains the immersion fluid in the gap 24. During the exposure, the immersion liquid is retained in the gap between the last optical element 16 and the upper surface of the substrate 26 and also the immersion liquid is retained between the fluid confinement member 50 and the upper surface of the substrate 16. In this embodiment, the immersion fluid covers a portion of the upper surface of the substrate. For more information on the fluid confinement member 50, see for example U.S. Patent publication 2004/0207824 A1, 2006/0087630 A1, and European Patent publication 1768170 A1, all disclosures incorporated herein by reference for all purposes. The porous chuck 24 holds the back surface of the substrate 26. As noted above, the fine stage 22 and the coarse stage 20 cooperate to move or position the substrate 26 under the projection optics system 14. One or more vacuum ports 52, which are couple to a vacuum source (not illustrated), are provided through the fine stage 22 to the porous chuck 28. The vacuum source is fluidly connected to the pores 30 of the chuck 24, holding the substrate 24 in place and sucking or otherwise removing any immersion liquid that may seep or otherwise collect under the substrate 26. In the embodiment shown, the chuck 24 has pins 34 across the top surface. In alternative embodiments, a non-pin chuck 24 may be used, such as that illustrated in FIG. 3.

The fluid confinement member 50 includes one or more fluid inlets to introduce the immersion fluid into the gap and/or one or more fluid outlets for removal of the immersion fluid from the gap. In this embodiment, one or more porous elements are provided at the one or more outlets. A vacuum source is fluidly connected to the one or more porous elements of the fluid confinement member 50. The vacuum sucks at a pressure equal to or below the bubble point of the one or more porous elements to remove the immersion fluid from the gap 28. For more details on liquid confinement member 50, see U.S. Patent Publication 2006/0152697 A1, and U.S. application Ser. No. 11/597,442 or PCT/US2005/14200, all incorporated herein by reference for all purposes.

Referring to FIG. 6, a cross section view of the porous chuck 24 in an immersion tool having a confinement plate according to another embodiment of the present invention is shown. In the embodiment shown, the immersion device 18 of FIG. 1 includes a fluid confinement member 60 that is sufficiently large to submerge the entire upper surface of the substrate 26 in the immersion fluid. Vacuum ports 52 are provided under the porous chuck 24. A vacuum (not illustrated) pulls a vacuum through the ports 52. The vacuum pressure, which is fluidly connected to the pores 30 of the chuck 24, hold the substrate 26 in place and suck or otherwise remove any immersion liquid that may seep or otherwise collect under the substrate 26. In the embodiment shown, the chuck 24 has pins 34 across the top surface. In alternative embodiments, a non-pin chuck 26 may be used, such as that illustrated in FIG. 3. The fine stage 22 includes a fluid recovery portion 54 that is provided adjacent to the porous chuck 24. In the embodiment illustrated, the fluid recovery portion 54 is a recessed portion or a groove provided on the fine stage 22, and substantially surrounds the periphery of the substrate 26. A porous material (or porous member) 56 is provided in the recessed portion. The fluid recovery portion 54 recovers any immersion fluid that overflows out from the gap between the substrate 26 and the fluid confinement member 60. A vacuum system (not illustrated) may be used to provide negative pressure to collect and discharge the immersion fluid recovered by the fluid recovery portion 54. At the bottom of the portion 54, one or more outlets connected to the vacuum system, are provided to discharge the immersion fluid recovered in the fluid recovery portion. During the exposure operation for the substrate 26, the immersion fluid is supplied from one or more inlets of the fluid confinement member 60, the entire upper surface of the substrate 26 is submerged in the immersion fluid, and any immersion fluid that overflows out from the gap between the upper surface of the substrate 26 and the under surface of the fluid confinement member 60 is recovered by the fluid recovery portion 54. For more details on containment plate type immersion lithography tools, see U.S. patent application Ser. No. 11/523,595, incorporated by reference herein. In some embodiments, the chuck 24 and the fluid recovery portion 54 are fluidly connected to each other. In some embodiments, the chuck 24 may be sufficiently large, as shown in FIGS. 3 and 4, to recover any immersion fluid that overflows out from the gap between the substrate 26 and the fluid confinement member 60. In this case, the fluid recovery portion 54 may be omitted. In some embodiments, the fluid confinement member 60 may include one or more outlets which recover any immersion fluid from above the substrate 26.

In FIGS. 5 and 6, the diameter of the chuck 24 is substantially the same as that of the substrate 26. This structure can prevent the immersion fluid from entering the space between the fine stage 22 and the substrate 26. Furthermore, the space between the fine stage 22 and the substrate 26 is substantially enclosed, and thus the substrate 26 is securely retained on the porous chuck 24 and any immersion liquid leaked into the porous chuck 24 or capillary absorbed by the porous chuck 24 is rapidly sucked and discharged through the vacuum ports 52.

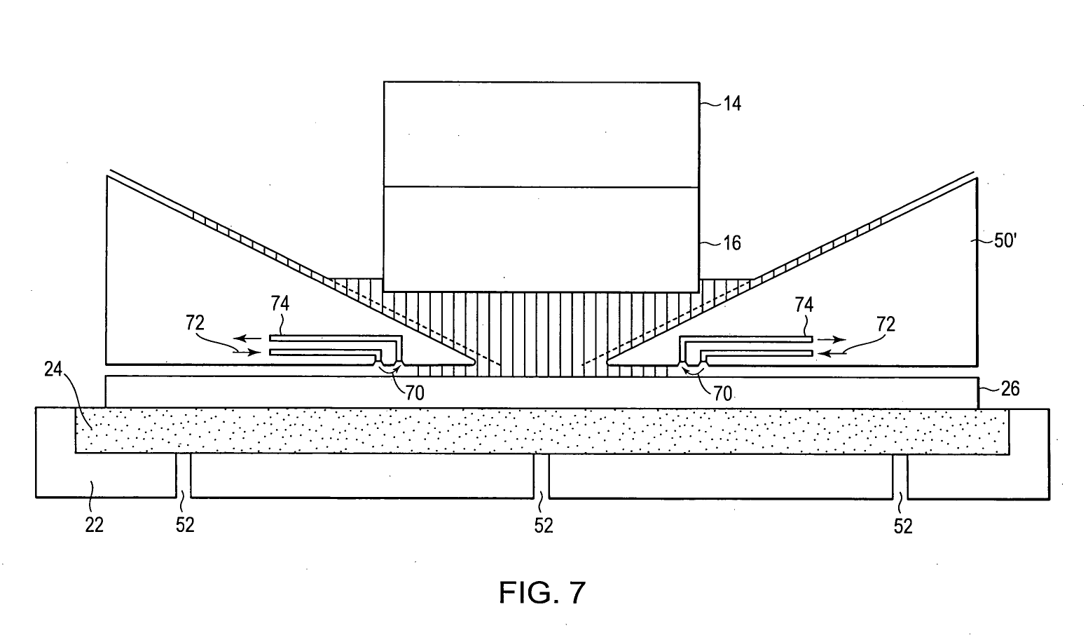

FIG. 7 shows one embodiment of the porous substrate chuck in an immersion tool using an air curtain. FIG. 7 is a cross section view of the porous substrate chuck in this embodiment. In this embodiment, the liquid confinement member 50′ forms an air curtain 70 with one or more air jets 72 that surround the last optical element of the projection optical system. The air jets 72 create a curtain of air surrounding the target exposure area and localizing the immersion fluid in the gap under the last optical element 16. The liquid confinement member 50′ further includes one or more vacuum ports 74, positioned adjacent the one or more air jets 72. The vacuum ports vacuum away any of the immersion fluid escaping the air curtain created by the jets 72. A vacuum (not illustrated) pulls a vacuum through the ports 52. The vacuum pressure, which is fluidly connected to the pores 30 of the chuck 24, hold the substrate 26 in place and suck or otherwise remove any immersion liquid that may seep or otherwise collect under the substrate 26. For more information on air curtain type immersion tools, see for example U.S. Patent publication 2005/0007569 or European Patent Applications EP 1 477 856 A1 and EP 420 299 A2, incorporated by reference herein for all purposes.

In certain embodiments, the immersion fluid is a liquid having a high index of refraction. In different embodiment, the liquid may be pure water or a liquid including “Decalin” or “Perhydropyrene”. In other embodiments, the immersion fluid can be a gas.

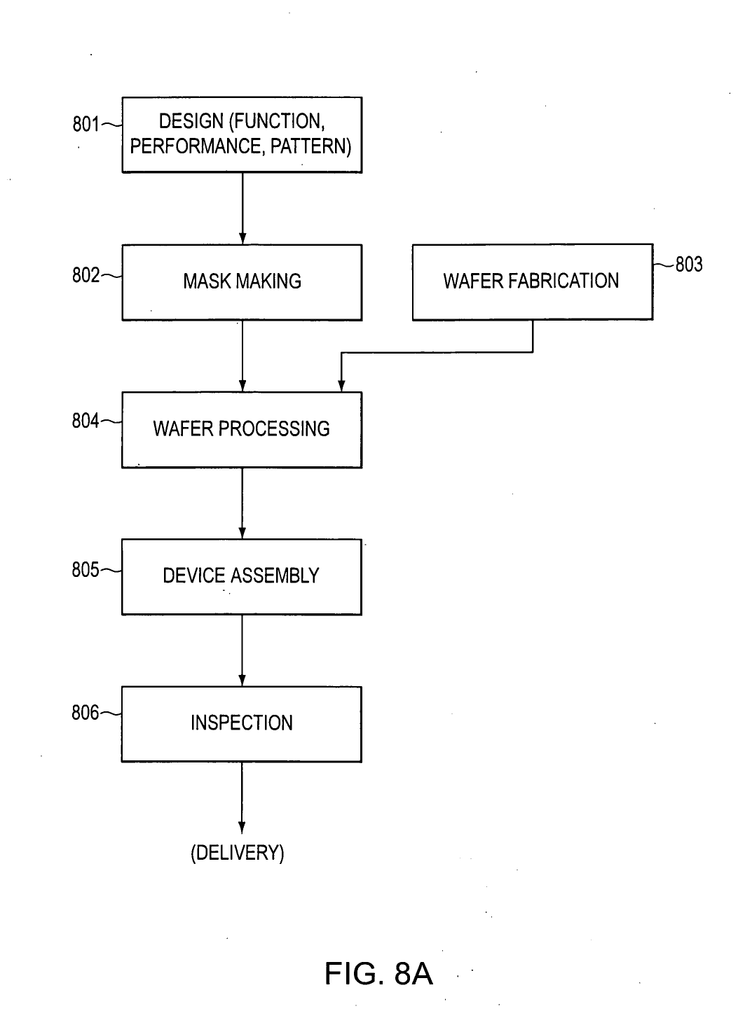

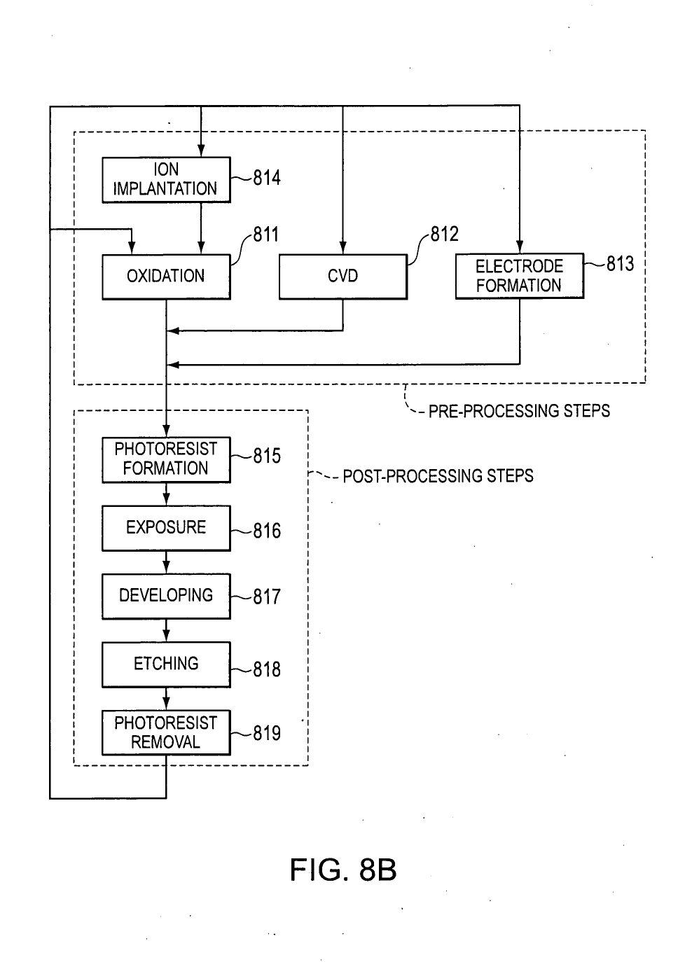

Semiconductor devices can be fabricated using the above described systems, by the process shown generally in FIG. 8A. In step 801 the device's function and performance characteristics are designed. Next, in step 802, a mask (reticle) having a pattern is designed according to the previous designing step, and in a parallel step 803 a wafer is made from a silicon material. The mask pattern designed in step 802 is exposed onto the wafer from step 803 in step 804 by a photolithography system described hereinabove in accordance with the present invention. In step 805 the semiconductor device is assembled (including the dicing process, bonding process and packaging process), finally, the device is then inspected in step 806.

FIG. 8B illustrates a detailed flowchart example of the above-mentioned step 804 in the case of fabricating semiconductor devices. In FIG. 8B, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above-mentioned steps 811-814 form the preprocessing steps for wafers during wafer processing, and selection is made at each step according to processing requirements.

It should be noted that the particular embodiments described herein are merely illustrative and should not be construed as limiting. For example, the substrate described herein does not necessarily have to be a semiconductor wafer. It could also be a flat panel used for making flat panel displays. Rather, the true scope of the invention is determined by the scope of the accompanying claims.

What is claimed is:

1. An apparatus, comprising:
a projection optical system having a last optical element, the projection optical system projecting an image onto a target area on a front surface of a substrate through an immersion liquid filled in a gap between the front surface of the substrate and the last optical element; and
a porous chuck that contacts a back surface of the substrate and holds the substrate in place, the porous substrate chuck facilitating the removal of the immersion liquid that may flow in a space adjacent to the back surface of the substrate.

2. The apparatus of claim 1, further comprising a vacuum system fluidly coupled to the porous chuck, the vacuum system pulling the immersion liquid that may flow in the space adjacent to the back surface of the substrate through the pores of the porous chuck.

3. The apparatus of claim 2, wherein the vacuum system is fluidly coupled to the porous chuck at one or more vacuum ports.

4. The apparatus of claim 1, wherein the porous chuck consists of one of the following materials: ceramic, metal, or glass.

5. The apparatus of claim 1, wherein the porous chuck further comprises a plurality of pores, the pores having a size ranging from 0.1 to 5 microns.

6. The apparatus of claim 1, wherein the porous chuck is has a size ranging from: 300 to 500 millimeters.

7. The apparatus of claim 1, wherein the porous chuck has a thickness ranging from 10 to 50 millimeters.

8. The apparatus of claim 1, wherein the porous chuck is mounted onto a stage using one of the following: magnets, a vacuum, mechanical fasteners, or a combination thereof.

9. The apparatus of claim 1, wherein the porous chuck is mounted onto a fine stage, the fine stage capable of moving the substrate held by the porous chuck from one to six degrees of freedom.

10. The apparatus of claim 9, wherein the fine stage is mounted onto a coarse stage, the coarse stage capable of moving the fine stage from one to six degrees to freedom.

11. The apparatus of claim 10, wherein the fine stage is supported on the coarse stage using one of the following: magnetic levitation, air bellows, pistons, vacuum, springs, or a combination thereof.

12. The apparatus of claim 9, wherein the fine stage is capable of moving the substrate held by the porous chuck in one of the following motions:
(i) a step-and-repeat motion; or
(ii) a scanning motion.

13. The apparatus of claim 1, further comprising:
a liquid confinement member that substantially surrounds the gap, the liquid confinement member including one or more liquid inlets to introduce the immersion liquid into the gap and one or more porous elements for removal of the immersion liquid from the gap.

14. The apparatus of claim 13, further comprising a vacuum system fluidly connected to the one or more porous elements of the liquid confinement member, the vacuum system providing a pressure on a surface of the one or more porous elements, the pressure being controlled at or below the bubble point of the one or more porous elements to remove the immersion liquid from the gap without any gas.

15. The apparatus of claim 1, further comprising:
a liquid confinement member that is sufficiently large to submerge at least the target exposure area of the substrate in the immersion liquid.

16. The apparatus of claim 1, further comprising:
a liquid confinement member that is sufficiently large to submerge the entire front surface of the substrate in the immersion liquid.

17. The apparatus of claim 1, further comprising:
an immersion element that forms a gas curtain with one or more gas inlets, the gas curtain being formed so as to surround the gap between the front surface of the substrate and the last optical element.

18. The apparatus of claim 17, wherein the immersion element further comprises one or more vacuum ports, positioned adjacent the one or more gas inlets.

19. A method, comprising:
providing a substrate having a front surface and a back surface on a porous chuck so that the back surface of the substrate contacts and is held by the porous chuck;
projecting an image onto a target area on the front surface of the substrate through an immersion liquid filled in a gap between the front surface of the substrate and a last optical element of a projection optical system; and
removing at least a portion of the immersion liquid through the porous chuck.

20. The method of claim 19, further comprising
fluidly connecting a vacuum system to the porous chuck to remove the immersion liquid through the pores of the porous chuck.

21. The method of claim 20, wherein the vacuum system is fluidly coupled to the porous chuck at one or more vacuum ports.

22. The method of claim 19, wherein the porous chuck consists of one of the following materials: ceramic, metal, or glass.

23. The method of claim 19, wherein the porous chuck further comprises a plurality of pores, the pores having a size ranging from 0.1 to 5 microns.

24. The method of claim 19, wherein the porous chuck has a size ranging from 300 to 500 microns.

25. The method of claim 19, wherein the porous chuck has a thickness ranging from 10 to 50 millimeters.

26. The method of claim 19, wherein the porous chuck is mounted onto a stage using one of the following: magnets, a vacuum, mechanical fasteners, or a combination thereof.

27. The method of claim 19, wherein the porous chuck is mounted on a fine stage, the fine stage capable of moving the substrate held by the porous chuck from one to six degrees of freedom.

28. The method of claim 27, wherein the fine stage is mounted on a coarse stage, the coarse stage capable of moving the fine stage from one to six degrees to freedom.

29. The method of claim 28, wherein the fine stage is supported on the coarse stage using one of the following: magnetic levitation, air bellows, pistons, vacuum, springs, or a combination thereof.

30. The method of claim 27, wherein the fine stage is capable of moving the substrate held by the porous chuck in one of the following motions:
(i) a step-and-repeat motion; or
(ii) a scanning motion.

31. The method of claim 19, further comprising:
introducing the immersion liquid into the gap through one or more liquid inlets; and
removing the introduced immersion liquid through one or more porous element from the gap.

32. The method of claim 31, further comprising:
fluidly connecting a vacuum system to the one or more porous element to remove the immersion liquid from the gap, the vacuum applying a pressure on a surface of the one or more porous elements, the pressure being controlled at or below the bubble point of the one or more porous elements to remove the immersion liquid without any gas.

33. The method of claim 19, wherein at least the target area of the substrate is submerged in the immersion liquid while the image is projected to the target area.

34. The method of claim 19, wherein the entire front surface of the substrate is immersed in the immersion liquid while the image is projected to the target area.

35. The method of claim 19, further comprising:
forming a gas curtain so as to surround the gap between the last optical element and the front surface of the substrate.

36. The method of claim 35, wherein the gas curtain is formed using one or more gas inlets and one or more vacuum ports, positioned adjacent the one or more gas inlets.

37. The apparatus of claim 1, wherein the porous chuck provides a dry surface for chucking the substrate by facilitating the removal of the immersion liquid that may collect between the back surface of the substrate and the porous substrate chuck.

38. The apparatus of claim 1, wherein the porous substrate chuck further comprises a plurality of pins.

39. The method of claim 19, wherein the porous substrate chuck provides a dry surface for chucking the substrate by facilitating the removal of the immersion liquid that may collect between the back surface of the substrate and the porous substrate chuck.

40. The method of claim 19, wherein a plurality of pins are provided on the porous substrate chuck.
